(19) United States
(12) Patent Application Publication
(10) Pub. No.: US 2026/0030496 A1
(43) Pub. Date: Jan. 29, 2026

(54) METHOD AND APPARATUS FOR OPTIMIZING DEEP LEARNING COMPUTATION GRAPH

(71) Applicant: Intel Corporation, Santa Clara, CA (US)

(72) Inventors: Ciyong CHEN, Shanghai (CN); Zhennan QIN, Shanghai (CN); Yunfei SONG, Shanghai (CN); Jun YE, Shanghai (CN)

(73) Assignee: Intel Corporation, Santa Clara, CA (US)

(21) Appl. No.: 18/995,106

(22) PCT Filed: Sep. 29, 2022
(86) PCT No.: PCT/CN2022/122907

§ 371 Date: Jan. 15, 2025

(51) Int. Cl. G06N 3/08; G06N 3/042

(52) U.S. Cl. CPC G06N 3/08; G06N 3/042

(57) ABSTRACT

Provided herein are apparatus and method for optimizing deep learning computation graph. The method includes obtaining a deep learning computation graph including compute-intensive operators and memory-intensive operators; fusing the memory-intensive operators into the compute-intensive operators to generate a new computation graph; dividing the new computation graph into sub-computation graphs; and fusing compute-intensive operators, in each of the sub-computation graphs, to generate an optimized computation graph. Other embodiments may also be disclosed and claimed.

### TECHNICAL FIELD

Embodiments described herein generally relate to deep learning (DL) networks, and more particularly relate to a method and an apparatus for optimizing deep learning computation graph.

### BACKGROUND ART

Deep Neural Networks (DNNs) models have become deeper and more complex nowadays with hundreds or even more layers. In order to obtain an appropriate DNN, a deep learning computation graph generated from its corresponding intermediate representation (IR) should be optimized. However, for such complex DNN, generally, the optimizing is computationally expensive and time consuming and may result in large cache pressure.

### SUMMARY

An aspect of the disclosure provides a method for optimizing deep learning computation graph, comprising: obtaining a deep learning computation graph comprising compute-intensive operators and memory-intensive operators; fusing the memory-intensive operators into the compute-intensive operators to generate a new computation graph; dividing the new computation graph into sub-computation graphs; and fusing compute-intensive operators, in each of the sub-computation graphs, to generate an optimized computation graph.

Another aspect of the disclosure provides an apparatus for optimizing deep learning computation graph, comprising: interface circuitry; and processor circuitry coupled with the interface circuitry and configured to: obtain a deep learning computation graph comprising compute-intensive operators and memory-intensive operators; fuse the memory-intensive operators into the compute-intensive operators to generate a new computation graph; divide the new computation graph into sub-computation graphs; and fuse compute-intensive operators, in each of the sub-computation graphs, to generate an optimized computation graph.

Another aspect of the disclosure provides a computer-readable medium having instructions stored thereon, the instructions when executed by a processor cause the processor to: obtain a deep learning computation graph comprising compute-intensive operators and memory-intensive operators; fuse the memory-intensive operators into the compute-intensive operators to generate a new computation graph; divide the new computation graph into sub-computation graphs; and fuse compute-intensive operators, in each of the sub-computation graphs, to generate an optimized computation graph.

### BRIEF DESCRIPTION OF THE DRAWINGS

Embodiments of the disclosure will be illustrated, by way of example and not limitation, in conjunction with the figures of the accompanying drawings in which like reference numerals refer to similar elements and wherein:

FIG. 1 illustrates a flowchart of an example of a method for optimizing deep learning computation graph according to an embodiment of the present application;

FIG. 2 illustrates a flowchart of another example of a method for optimizing deep learning computation graph according to an embodiment of the present application;

FIG. 3 illustrates a flowchart of another example of a method for optimizing deep learning computation graph according to an embodiment of the present application;

FIG. 4 illustrates a flowchart of another example of a method for optimizing deep learning computation graph according to an embodiment of the present application;

FIG. 5 illustrates a schematic diagram of an example of dividing for batch and sample according to an embodiment of the present application;

FIG. 6 illustrates a schematic diagram of another example of dividing for sample according to an embodiment of the present application;

FIG. 7 illustrates a block diagram of an example of an apparatus for optimizing deep learning computation graph according to an embodiment of the present application;

FIG. 8 is a block diagram illustrating components, according to some example embodiments, able to read instructions from a machine-readable or computer-readable medium and perform any one or more of the methodologies discussed herein; and

FIG. 9 is a block diagram of an example processor platform in accordance with some embodiments of the disclosure.

### DETAILED DESCRIPTION OF EMBODIMENTS

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B)”.

In order to obtain an appropriate deep neural network (DNN) from a deep learning framework, generally, the following processing stages may be performed:
a) Graph construction stage, in which a computation graph is built via its intermediate representation (IR) according to the information from the deep learning framework;
b) Compilation stage, in which the computation graph is transformed (e.g., optimized), while the IR is optimized and lowered to the hardware specific IR; and
c) Code generation stage, in which the binary code or equivalent representation is generated based on the optimized IR.

During the Compilation stage, the computation graph is optimized, for example, by operator fusion.

Traditionally, the operator fusion is usually performed by applying a fixed pattern approach or a polyhedral-based loop fusion. However, the fixed pattern approach is restricted by the fixed particular operators therein, and cannot be universally used. The polyhedral-based loop fusion may miss potential fusion opportunities due to the lacking of operator-level information.

Further, for a complex DNN with a larger number of layers, the efficient of the above approaches may be very low and they may cause a large cache pressure.

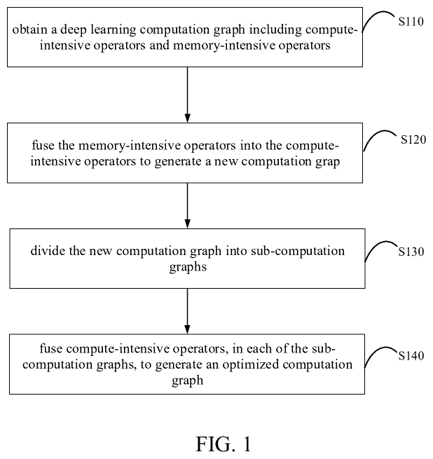

FIG. 1 illustrates a flowchart of an example of a method for optimizing deep learning computation graph according to an embodiment of the present application.

The method herein may be performed by any suitable device, such as a deep learning compiler or a processor.

The deep learning computation graph herein may be a deep learning computation graph for any DNN model (such as a convolution neural network (CNN) model with a large batch size) for inference (e.g., RN50 throughput in MLPerf) or for training (e.g., with a deep learning recommendation mode (DLRM)). The deep learning computation graph may be a computation graph built by a deep learning compiler as described above.

Referring to FIG. 1, in block S110, a deep learning computation graph including compute-intensive operators and memory-intensive operators is obtained.

For example, the compute-intensive operator of the deep learning computation graph may be a convolution or a matmul. The memory-intensive operator may be an elementwise, a binary or a memory movement. Generally, for a deep learning computation graph for a CNN model, the compute-intensive operator may be followed by one or more memory-intensive operators.

In block S120, the memory-intensive operators are fused into the compute-intensive operators to generate a new computation graph.

In an embodiment, one or more sequential memory-intensive operators may be fused into a previous or a following compute-intensive operator. In this way, a new computation graph may be generated. The new computation graph may include a plurality of layers, and each of the layers may include a plurality of compute-intensive operators. Thus, the new computation graph includes only compute-intensive operators.

In block S130, the new computation graph is divided into sub-computation graphs.

For example, each sub-computation graph may include one or more layers of the new computation graph.

In an embodiment, the new computation graph may be divided into the sub-computation graphs, based on an output property of each layer of the new computation graph and a platform capacity of a platform on which the new computation graph is to be executed.

For example, the output property of each layer may be an output property indicating the capacity of buffer which should be allocated for this layer for operator fusion.

In an embodiment, each of the compute-intensive operators of the new computation graph may output an output activation, and the output activations of the compute-intensive operators of each layer form an output batch. The output property may include a size of an output batch for each layer and/or a size of an output activation of each compute-intensive operator of the new computation graph.

As for the platform capacity, in an embodiment, the new computation graph may be executed on a central processing unit (CPU), and then the platform capacity may include a size of a data cache unit (DCU) and a size of a middle level cell (MLC) of the CPU.

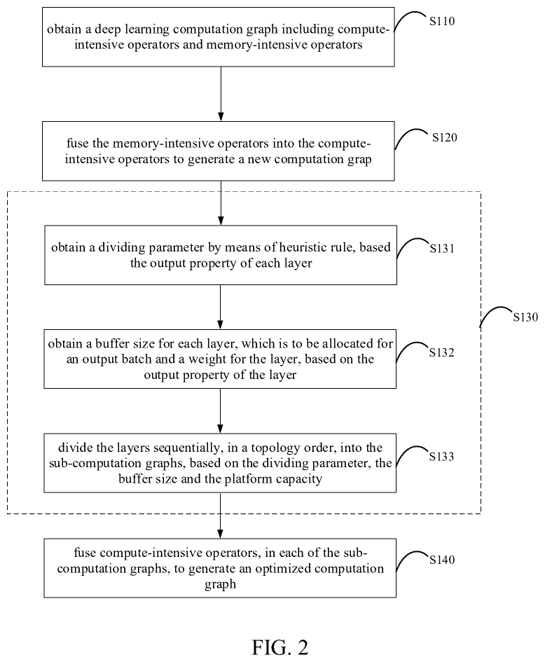

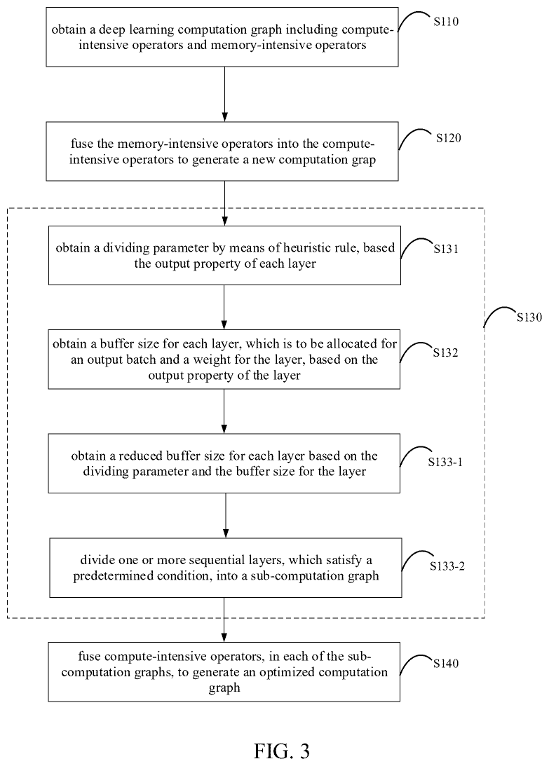

The embodiments of the dividing for sub-computation graphs based on an output property and the platform capacity in block S130 will be further described with respect to the following FIG. 2 and FIG. 3.

In block S140, the compute-intensive operators are fused, in each of the sub-computation graphs, to generate an optimized computation graph.

For example, after the compute-intensive operators are fused in each of the sub-computation graphs, all the compute-intensive operators will form the optimized computation graph.

By dividing the computation graph into the sub-computation graphs and fusing the operators in the individual sub-computation graphs, respectively, the efficient and the cache pressure for optimizing deep learning computation graph may be improved.

FIG. 2 illustrates a flowchart of another example of a method for optimizing deep learning computation graph according to an embodiment of the present application.

In FIG. 2, the blocks S110, S120 and S140 are similar to the blocks S110, S120 and S140 in FIG. 1, and the difference between FIG. 2 and FIG. 1 lies in that: the block S130 in FIG. 1 is specifically illustrated by blocks S131, S132 and S133 in FIG. 2.

Referring to FIG. 2, in block S131, a dividing parameter is obtained by means of heuristic rule, based the output property of each layer.

In an embodiment, the dividing parameter may include a batch dividing number (x) and a spatial dividing number (y). The batch dividing number may correspond to a number of sub-batches which an output batch is to be divided into, and the spatial dividing number may correspond to a number of sub-activations which an output activation is to be divided into. The dividing for the sub-batches and the sub-activations will be further described below.

In block S132, a buffer size (aᵢ) for each layer, which is to be allocated for an output batch and a weight for the layer, is obtained based on the output property of the layer.

The buffer size used for each layer can be estimated by means of any estimation method.

In block S133, the layers are sequentially divided into the sub-computation graphs, in a topology order of the new computation graph, based on the dividing parameter, the buffer size and the platform capacity.

An embodiment of the dividing of the layers in block S133 will be described with respected to the following FIG. 3.

FIG. 3 illustrates a flowchart of another example of a method for optimizing deep learning computation graph according to an embodiment of the present application.

In FIG. 3, the blocks S110, S120, S130 and S140 are similar to the blocks S110, S120, S130 and S140 in FIG. 2, and the difference between FIG. 3 and FIG. 2 lies in that: the block S133 in FIG. 2 is specifically illustrated by blocks S133-1 and S133-2 in FIG. 3.

Referring to FIG. 3, in block S133-1, a reduced buffer size (a_{R_i}) for each layer is obtained based on the dividing parameter (x and y) and the buffer size (aᵢ) for the layer.

In an embodiment, the reduced buffer size may be expressed by the following equation (1):

$${a}_{R\_i} = {w}_{i} + {a}_{i} \times \frac{1}{x \times y} \qquad ( 1 )$$

In the equation (1), a_{R_i} indicates the reduced buffer size for a i^{th} layer of the new computation graph in the topology order, wᵢ indicates the weight for the i^{th} layer, at indicates the buffer size for the i^{th} layer, x indicates the batch dividing number, y indicates the spatial dividing number, and each of the a_{R_i}, i, wᵢ, aᵢ, x and y is greater than 0.

In block S133-2, one or more sequential layers, which satisfy a predetermined condition, are divided into a sub-computation graph.

In an embodiment, in block S133-2, the one or more sequential layers, for which a sum of the reduced buffer sizes for the one or more sequential layers is smaller than or equal to the platform capacity and a sum of the reduced buffer sizes for the one or more sequential layers and a following layer is greater than the platform capacity, are divided into a sub-computation graph.

In other words, the reduced buffer sizes may be accumulated layer-by-layer, from the first layer of the new computation graph, and once the above predetermined condition is satisfied, the accumulation will be re-performed from the next layer.

In an embodiment, for each sub-computation graph, the following equation (2) is satisfied:

$${\sum }_{i = N}^{i = M} {a}_{R\_i} \leq T \times ( {L}_{1} + {L}_{2} ) < {\sum }_{i = N}^{i = M + 1} {a}_{R\_i} \qquad ( 2 )$$

In the equation (2), N indicates a start layer of the sub-computation graph, M indicates a last layer of the sub-computation graph, T indicates a threshold set based on the CPU, L₁ indicates the size of the DCU, L₂ indicates the size of the MLC, the N, M, L₁ and L₂ are greater than 0, and T is greater than 0 and smaller than or equal to 1 (e.g., T ranges from 0.9 to 0.95).

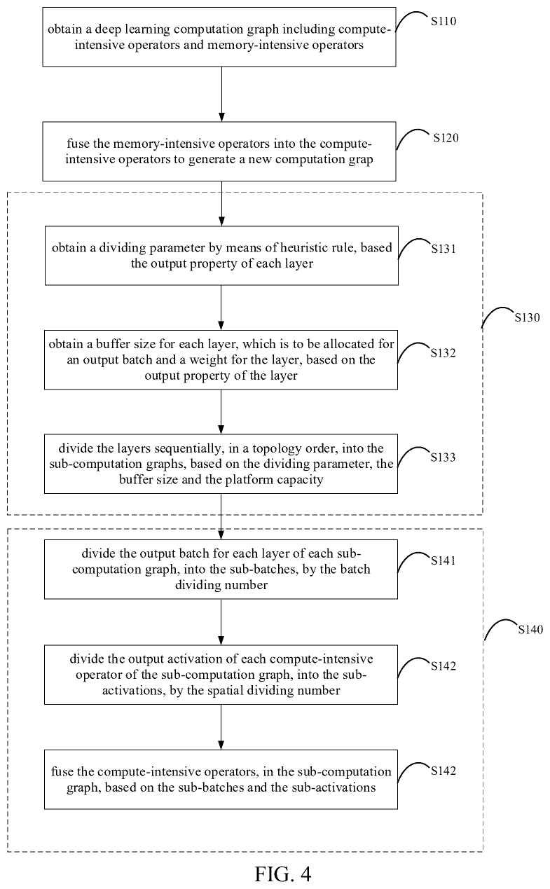

After the completion of the dividing of the sub-computation graphs, the fusing of the compute-intensive operators may be performed. An embodiment of the fusing is shown in the following FIG. 4.

FIG. 4 illustrates a flowchart of another example of a method for optimizing deep learning computation graph according to an embodiment of the present application.

In FIG. 4, the blocks S110, S120 and S130 are similar to the blocks S110, S120 and S130 in FIG. 2, and the difference between FIG. 4 and FIG. 2 lies in that: the block S140 in FIG. 2 is specifically illustrated by blocks S141 and S142 in FIG. 4.

Referring to FIG. 4, in block S141, the output batch for each layer of the sub-computation graph, is divided into the sub-batches, by the batch dividing number.

For example, if the batch dividing number is determined as 2, the output batch for each layer will be divided into 2 sub-batches.

In block S142, the output activation of each compute-intensive operator of the sub-computation graph, is divided into the sub-activations, by the spatial dividing number.

For example, if the spatial dividing number is determined as 3, the output activation of each compute-intensive operator will be divided into 3 sub-activations.

In an embodiment, each output activation may include one or more output samples (and each sample may include one or more channels).

In this condition, the dividing in block S142 may be performed by dividing each output sample of the output activation into sub-samples, along a height direction of the sample, by the spatial dividing number.

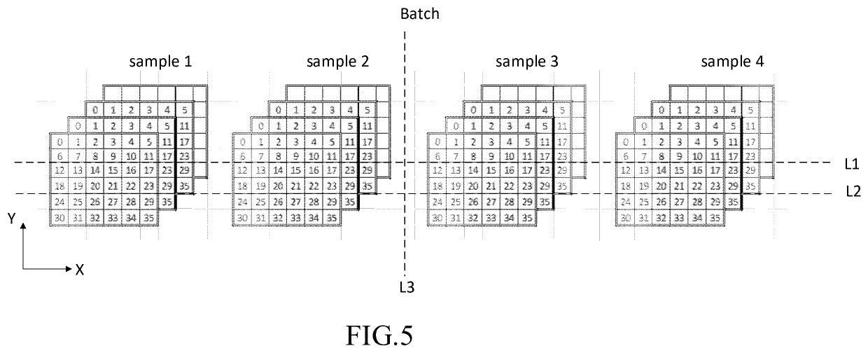

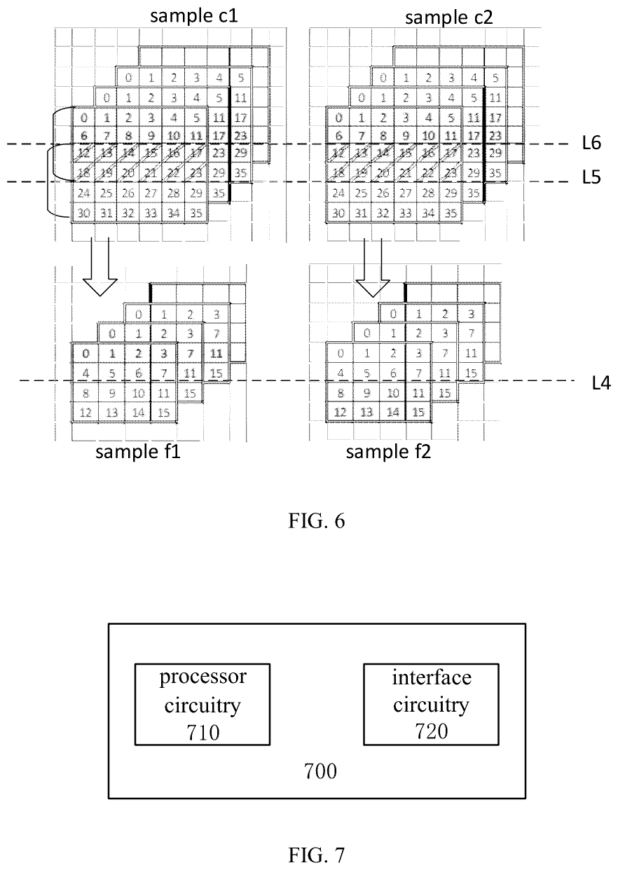

The embodiments of the dividing for sub-batches and the sub-activations will be further described with respect to the following FIG. 5 and FIG. 6.

In block S143, the compute-intensive operators are fused in the sub-computation graph, based on the sub-batches and the sub-activations.

The fusing of the compute-intensive operators in block S143 may be implemented by means of any suitable fusing solution.

The following table 1 provides an example machine readable language for implementing the fusing in block S140.

TABLE 1

```
Outer Loop{ // batch axis
Inner loop { // height axis (optional)
    partial compute-intensive op1
    partial compute-intensive op2
  }
}
Outer Loop{ // batch axis
Inner loop { // height axis (optional)
    partial compute-intensive op3
    ...
    partial compute-intensive opN
  }
}
```

It should be understood that the fusing in block S140 may be implemented by any other machine readable language which may realize the fusing as described above.

FIG. 5 illustrates a schematic diagram of an example of dividing for batch and sample according to an embodiment of the present application.

FIG. 5 shows an output batch including 4 samples, which are sample 1, sample 2, sample 3 and sample 4. Each sample includes 4 channels. For example, if the computation graph is used for processing image with 4 channels (e.g., red, green, blue and write channels), each sample may include 4 corresponding channels.

In FIG. 5, the directions of X axis and Y axis indicated by the arrows are a batch direction for dividing the batch and a height direction for dividing the samples, respectively.

In the embodiment shown in FIG. 5, the batch dividing number x is 2, and the spatial dividing number y is 3. The output batch is divided into 2 sub-batches, along the batch direction X, as indicated by line L3, one of the sub-batches includes the samples 1 and 2, and the other sub-batch includes the samples 3 and 4. Each of the samples 1, 2, 3 and 4 is divided into 3 sub-samples, along the height direction Y, as indicated by lines L1 and L2.

This diving for the sample may be suitable for the case that the corresponding compute-intensive operators of two sequential layers have kernels with the same dimension, e.g., 1×1 convolution kernels (e.g., with stride=1).

In the case that the corresponding compute-intensive operators of two sequential layers have kernels with different dimensions, the dividing for the samples of a current layer may be dependent on the output samples of a following layer. An embodiment of this case is shown in the following FIG. 6.

FIG. 6 illustrates a schematic diagram of another example of dividing for sample according to an embodiment of the present application.

In the embodiment shown in FIG. 6, samples c1 and c2 are samples output from a current layer, and samples f1 and f2 are samples output from a following layer. The spatial dividing number y is 2. The kernel of the compute-intensive operator corresponding to the samples c1 or c2 is a 1×1 convolution kernel (e.g., with stride=1), and the kernel of the compute-intensive operator corresponding to the samples f1 or f2 is a 3×3 convolution kernel (e.g., with stride=1).

In this case, in order to obtain 2 sub-samples for the sample f1 or f2 (as indicated by line L4), each sub-sample divided from the corresponding sample c1 or c2 should include four rows of the rows shown in the sample c1 or c2. That is, for the sample c1 or c2, the first four rows may be divided into a sub-sample (as indicated by line L5), and the last four rows may be divided into another sub-sample (as indicated by line L6), which means that the middle two rows will be reused by the two sub-samples.

It should be understood that the above dividing for the output batch and the sample, and the above dimensions of kernels of the compute-intensive operators are only provided as examples, the batch and sample can be divided through any other way, and the kernels of the compute-intensive operators may have other dimensions, according to actual requirements.

According to the method for optimizing deep learning computation graph of the embodiments of the present application, the optimizing efficient and cache pressure may be improved by dividing the computation graph into the sub-computation graphs and fusing the operators in the individual sub-computation graphs, respectively.

FIG. 7 illustrates a block diagram of an example of an apparatus 700 for optimizing deep learning computation graph according to an embodiment of the present application.

Referring to FIG. 7, the apparatus 700 for optimizing deep learning computation graph according to an embodiment of the present application includes a processor circuitry 710 and an interface circuitry 720 which are coupled with each other.

The processor circuitry 710 may be a deep learning compiler or any other processor. The processor circuitry 710 is configured to: obtain a deep learning computation graph including compute-intensive operators and memory-intensive operators; fuse the memory-intensive operators into the compute-intensive operators to generate a new computation graph; divide the new computation graph into sub-computation graphs; and fuse compute-intensive operators, in each of the sub-computation graphs, to generate an optimized computation graph.

In an embodiment, the processor circuitry 710 may be configured to fuse the memory-intensive operators into the compute-intensive operators by: fusing one or more sequential memory-intensive operators into a previous or a following compute-intensive operator, to generate the new computation graph.

In an embodiment, the new computation graph may include a plurality of layers, and each of the layers may include a plurality of compute-intensive operators.

In an embodiment, the new computation graph may be divided into the sub-computation graphs, based on an output property of each layer of the new computation graph and a platform capacity of a platform on which the new computation graph is to be executed.

In an embodiment, each of the compute-intensive operators of the new computation graph outputs an output activation, and the output activations of the compute-intensive operators of each layer form an output batch. The output property may include a size of an output batch for each layer, and/or a size of an output activation of each compute-intensive operator of the new computation graph.

In an embodiment, the platform capacity may include a size of a data cache unit (DCU) and a size of a middle level cell (MLC) of a central processing unit (CPU) on which the new computation graph is to be executed.

In an embodiment, the processor circuitry 710 may be configured to divide the new computation graph into the sub-computation graphs by: obtaining a dividing parameter by means of heuristic rule, based the output property of each layer; obtaining a buffer size for each layer, which is to be allocated for an output batch and a weight for the layer, based on the output property of the layer; and dividing the layers sequentially, in a topology order of the new computation graph, into the sub-computation graphs, based on the dividing parameter, the buffer size and the platform capacity.

In an embodiment, the dividing parameter may include a batch dividing number and a spatial dividing number. The batch dividing number may correspond to a number of sub-batches which an output batch is to be divided into, and the spatial dividing number may correspond to a number of sub-activations which an output activation is to be divided into.

In an embodiment, the processor circuitry 710 may be configured to divide the layers sequentially, in the topology order of the new computation graph, into the sub-computation graphs, based on the dividing parameter, the buffer size and the platform capacity by: obtaining a reduced buffer size for each layer based on the dividing parameter and the buffer size for the layer; and dividing one or more sequential layers, for which a sum of the reduced buffer sizes for the one or more sequential layers is smaller than or equal to the platform capacity and a sum of the reduced buffer sizes for the one or more sequential layers and a following layer is greater than the platform capacity, into a sub-computation graph.

In an embodiment, the reduced buffer size may be expressed by the above equation (1), and each divided sub-computation graph may satisfy the above equation (2).

In an embodiment, the processor circuitry 710 may be configured to fuse the compute-intensive operators, in each of the sub-computation graphs by: for each sub-computation graph, dividing the output batch for each layer of the sub-computation graph, into the sub-batches, by the batch dividing number; dividing the output activation of each compute-intensive operator of the sub-computation graph, into the sub-activations, by the spatial dividing number; and fusing the compute-intensive operators, in the sub-computation graph, based on the sub-batches and the sub-activations.

In an embodiment, the processor circuitry 710 may be configured to divide the output activation of each compute-intensive operator of the sub-computation graph, into the sub-activations, by the spatial dividing number by: dividing each output sample of the output activation into sub-samples, along a height direction of the sample, by the spatial dividing number.

The details of the operations performed by the processor circuitry 710 of the apparatus 700 for optimizing deep learning computation graph may refer to the above embodiments shown in FIG. 1 to FIG. 6, which will not be repeated herein.

According to the apparatus for optimizing deep learning computation graph of the embodiments of the present application, the optimizing efficient and cache pressure may be improved by dividing the computation graph into the sub-computation graphs and fusing the operators in the individual sub-computation graphs, respectively.

Further, a computer-readable medium is provided. The computer-readable medium is stored with instructions. The instructions when executed by a processor cause the processor to: obtain a deep learning computation graph comprising compute-intensive operators and memory-intensive operators; fuse the memory-intensive operators into the compute-intensive operators to generate a new computation graph; divide the new computation graph into sub-computation graphs; and fuse compute-intensive operators, in each of the sub-computation graphs, to generate an optimized computation graph.

For example, the instructions when executed by a processor may cause the processor to perform the operations as described above with respected to FIG. 1 to FIG. 6, which will not be repeated herein.

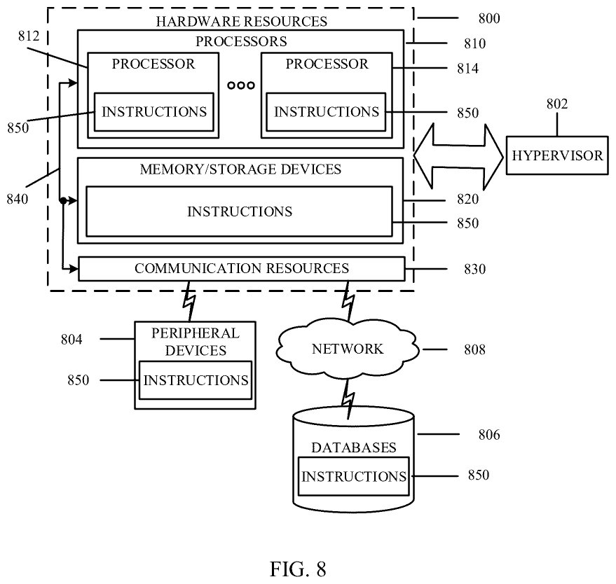

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814 which may be, e.g., a central processing unit (CPU), a graphics processing unit (GPU), a tensor processing unit (TPU), a visual processing unit (VPU), a field programmable gate array (FPGA), or any suitable combination thereof.

The memory/storage devices 820 may include main memory, disk storage, or any suitable combination thereof. The memory/storage devices 820 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 830 may include interconnection or network interface components or other suitable devices to communicate with one or more peripheral devices 804 or one or more databases 806 via a network 808. For example, the communication resources 830 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

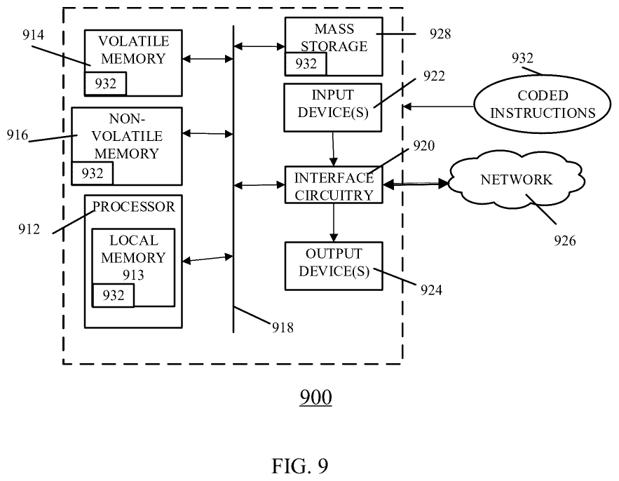

FIG. 9 is a block diagram of an example processor platform in accordance with some embodiments of the disclosure. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 900 of the illustrated example includes a processor 912. The processor 912 of the illustrated example is hardware. For example, the processor 912 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes interface circuitry 920. The interface circuitry 920 may be implemented by any type of interface standard, such as an Ethernet interface, a universal serial bus (USB), a Bluetooth® interface, a near field communication (NFC) interface, and/or a PCI express interface.

In the illustrated example, one or more input devices 922 are connected to the interface circuitry 920. The input device(s) 922 permit(s) a user to enter data and/or commands into the processor 912. The input device(s) can be implemented by, for example, an audio sensor, a microphone, a camera (still or video), a keyboard, a button, a mouse, a touchscreen, a track-pad, a trackball, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 920 of the illustrated example, thus, typically includes a graphics driver card, a graphics driver chip and/or a graphics driver processor.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 926. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 920 may include a training dataset inputted through the input device(s) 922 or retrieved from the network 926.

The processor platform 900 of the illustrated example also includes one or more mass storage devices 928 for storing software and/or data. Examples of such mass storage devices 928 include floppy disk drives, hard drive disks, compact disk drives, Blu-ray disk drives, redundant array of independent disks (RAID) systems, and digital versatile disk (DVD) drives.

Machine executable instructions 932 may be stored in the mass storage device 928, in the volatile memory 914, in the non-volatile memory 916, and/or on a removable non-transitory computer readable storage medium such as a CD or DVD.

The following paragraphs describe examples of various embodiments.

Example 1 includes a method for optimizing deep learning computation graph, comprising: obtaining a deep learning computation graph comprising compute-intensive operators and memory-intensive operators; fusing the memory-intensive operators into the compute-intensive operators to generate a new computation graph; dividing the new computation graph into sub-computation graphs; and fusing compute-intensive operators, in each of the sub-computation graphs, to generate an optimized computation graph.

Example 2 includes the method of Example 1, wherein fusing the memory-intensive operators into the compute-intensive operators comprises: fusing one or more sequential memory-intensive operators into a previous or a following compute-intensive operator.

Example 3 includes the method of Example 1 or 2, wherein the new computation graph comprises a plurality of layers, and each of the layers comprises a plurality of compute-intensive operators, and wherein the new computation graph is divided into the sub-computation graphs, based on an output property of each layer of the new computation graph and a platform capacity of a platform on which the new computation graph is to be executed.

Example 4 includes the method of any one of Examples 1-3, wherein dividing the new computation graph into the sub-computation graphs comprises: obtaining a dividing parameter by means of heuristic rule, based the output property of each layer; obtaining a buffer size for each layer, which is to be allocated for an output batch and a weight for the layer, based on the output property of the layer; and dividing the layers sequentially, in a topology order of the new computation graph, into the sub-computation graphs, based on the dividing parameter, the buffer size and the platform capacity.

Example 5 includes the method of any one of Examples 1-4, wherein dividing the layers sequentially, in the topology order of the new computation graph, into the sub-computation graphs, based on the dividing parameter, the buffer size and the platform capacity comprises: obtaining a reduced buffer size for each layer based on the dividing parameter and the buffer size for the layer; and dividing one or more sequential layers, for which a sum of the reduced buffer sizes for the one or more sequential layers is smaller than or equal to the platform capacity and a sum of the reduced buffer sizes for the one or more sequential layers and a following layer is greater than the platform capacity, into a sub-computation graph.

Example 6 includes the method of any one of Examples 1-5, wherein each of the compute-intensive operators of the new computation graph outputs an output activation, and the output activations of the compute-intensive operators of each layer form an output batch, and wherein the output property comprises a size of an output batch for each layer and/or a size of an output activation of each compute-intensive operator of the new computation graph.

Example 7 includes the method of any one of Examples 1-6, wherein the dividing parameter comprises a batch dividing number and a spatial dividing number, wherein the batch dividing number corresponds to a number of sub-batches which an output batch is to be divided into, and the spatial dividing number corresponds to a number of sub-activations which an output activation is to be divided into.

Example 8 includes the method of any one of Examples 1-7, wherein the reduced buffer size is expressed by:

$${a}_{R\_i} = {w}_{i} + {a}_{i} \times \frac{1}{x \times y} ,$$

wherein a_{R_i} indicates the reduced buffer size for a i^{th} layer of the new computation graph in the topology order, w; indicates the weight for the i^{th} layer, aᵢ indicates the buffer size for the i^{th} layer, x indicates the batch dividing number, y indicates the spatial dividing number, and each of the a_{R_i}, i, wᵢ, aᵢ, x and y is greater than 0.

Example 9 includes the method of any one of Examples 1-8, wherein the platform capacity comprises a size of a data cache unit (DCU) and a size of a middle level cell (MLC) of a central processing unit (CPU) on which the new computation graph is to be executed.

Example 10 includes the method of any one of Examples 1-9, wherein for each sub-computation graph:

$${Σ}_{i = N}^{i = M} {a}_{R\_i} \leq T \times ( {L}_{1} + {L}_{2} ) < {Σ}_{i = N}^{i = M + 1} {a}_{R\_i} ,$$

wherein N indicates a start layer of the sub-computation graph, M indicates a last layer of the sub-computation graph, T indicates a threshold set based on the CPU, L₁ indicates the size of the DCU, L₂ indicates the size of the MLC, the N, M, L₁ and L₂ are greater than 0, and T is greater than 0 and smaller than or equal to 1.

Example 11 includes the method of any one of Examples 1-10, wherein fusing the compute-intensive operators, in each of the sub-computation graphs comprises: for each sub-computation graph, dividing the output batch for each layer of the sub-computation graph, into the sub-batches, by the batch dividing number; dividing the output activation of each compute-intensive operator of the sub-computation graph, into the sub-activations, by the spatial dividing number; and fusing the compute-intensive operators, in the sub-computation graph, based on the sub-batches and the sub-activations.

Example 12 includes the method of any one of Examples 1-11, wherein each output activation comprises one or more output samples, and wherein dividing the output activation of each compute-intensive operator of the sub-computation graph, into the sub-activations, by the spatial dividing number comprises: dividing each output sample of the output activation into sub-samples, along a height direction of the sample, by the spatial dividing number.

Example 13 includes an apparatus for optimizing deep learning computation graph, comprising: interface circuitry; and processor circuitry coupled with the interface circuitry and configured to: obtain a deep learning computation graph comprising compute-intensive operators and memory-intensive operators; fuse the memory-intensive operators into the compute-intensive operators to generate a new computation graph; divide the new computation graph into sub-computation graphs; and fuse compute-intensive operators, in each of the sub-computation graphs, to generate an optimized computation graph.

Example 14 includes the apparatus of Example 13, wherein the processor circuitry is configured to fuse the memory-intensive operators into the compute-intensive operators by: fuse one or more sequential memory-intensive operators into a previous or a following compute-intensive operator.

Example 15 includes the apparatus of Example 13 or 14, wherein the new computation graph comprises a plurality of layers, and each of the layers comprises a plurality of compute-intensive operators, and wherein the new computation graph is divided into the sub-computation graphs, based on an output property of each layer of the new computation graph and a platform capacity of a platform on which the new computation graph is to be executed.

Example 16 includes the apparatus of any one of Examples 13-15, wherein the processor circuitry is configured to divide the new computation graph into the sub-computation graphs by: obtaining a dividing parameter by means of heuristic rule, based the output property of each layer; obtaining a buffer size for each layer, which is to be allocated for an output batch and a weight for the layer, based on the output property of the layer; and dividing the layers sequentially, in a topology order of the new computation graph, into the sub-computation graphs, based on the dividing parameter, the buffer size and the platform capacity.

Example 17 includes the apparatus of any one of Examples 13-16, wherein the processor circuitry is configured to divide the layers sequentially, in the topology order of the new computation graph, into the sub-computation graphs, based on the dividing parameter, the buffer size and the platform capacity by: obtaining a reduced buffer size for each layer based on the dividing parameter and the buffer size for the layer; and dividing one or more sequential layers, for which a sum of the reduced buffer sizes for the one or more sequential layers is smaller than or equal to the platform capacity and a sum of the reduced buffer sizes for the one or more sequential layers and a following layer is greater than the platform capacity, into a sub-computation graph.

Example 18 includes the apparatus of any one of Examples 13-17, wherein each of the compute-intensive operators of the new computation graph outputs an output activation, and the output activations of the compute-intensive operators of each layer form an output batch, and wherein the output property comprises a size of an output batch for each layer and/or a size of an output activation of each compute-intensive operator of the new computation graph.

Example 19 includes the apparatus of any one of Examples 13-18, wherein the dividing parameter comprises a batch dividing number and a spatial dividing number, wherein the batch dividing number corresponds to a number of sub-batches which an output batch is to be divided into, and the spatial dividing number corresponds to a number of sub-activations which an output activation is to be divided into.

Example 20 includes the apparatus of any one of Examples 13-19, wherein the reduced buffer size is expressed by:

$${a}_{R\_i} = {w}_{i} + {a}_{i} \times \frac{1}{x \times y} ,$$

wherein a_{R_i} Indicates the reduced buffer size for a i^{th} layer of the new computation graph in the topology order, wᵢ indicates the weight for the i^{th} layer, aᵢ indicates the buffer size for the i^{th} layer, x indicates the batch dividing number, y indicates the spatial dividing number, and each of the a_{R_i}, i, wᵢ, aᵢ, x and y is greater than 0.

Example 21 includes the apparatus of any one of Examples 13-20, wherein the platform capacity comprises a size of a data cache unit (DCU) and a size of a middle level cell (MLC) of a central processing unit (CPU) on which the new computation graph is to be executed.

Example 22 includes the apparatus of any one of Examples 13-21, wherein for each sub-computation graph:

$${Σ}_{i = N}^{i = M} {a}_{R\_i} \leq T \times ( {L}_{1} + {L}_{2} ) < {Σ}_{i = N}^{i = M + 1} {a}_{R\_i} ,$$

wherein N indicates a start layer of the sub-computation graph, M indicates a last layer of the sub-computation graph, T indicates a threshold set based on the CPU, L₁ indicates the size of the DCU, L₂ indicates the size of the MLC, the N, M, L₁ and L₂ are greater than 0, and T is greater than 0 and smaller than or equal to 1.

Example 23 includes the apparatus of any one of Examples 13-22, wherein the processor circuitry is configured to fuse the compute-intensive operators, in each of the sub-computation graphs by: for each sub-computation graph, dividing the output batch for each layer of the sub-computation graph, into the sub-batches, by the batch dividing number; dividing the output activation of each compute-intensive operator of the sub-computation graph, into the sub-activations, by the spatial dividing number; and fusing the compute-intensive operators, in the sub-computation graph, based on the sub-batches and the sub-activations.

Example 24 includes the apparatus of any one of Examples 13-23, wherein each output activation comprises one or more output samples, and wherein the processor circuitry is configured to divide the output activation of each compute-intensive operator of the sub-computation graph, into the sub-activations, by the spatial dividing number by: dividing each output sample of the output activation into sub-samples, along a height direction of the sample, by the spatial dividing number.

Example 25 includes an apparatus for optimizing deep learning computation graph, comprising: means for obtaining a deep learning computation graph comprising compute-intensive operators and memory-intensive operators; means for fusing the memory-intensive operators into the compute-intensive operators to generate a new computation graph; means for dividing the new computation graph into sub-computation graphs; and means for fusing compute-intensive operators, in each of the sub-computation graphs, to generate an optimized computation graph.

Example 26 includes the apparatus of Example 25, wherein the means for fusing the memory-intensive operators into the compute-intensive operators comprises: means for fusing one or more sequential memory-intensive operators into a previous or a following compute-intensive operator.

Example 27 includes the apparatus of Example 25 or 26, wherein the new computation graph comprises a plurality of layers, and each of the layers comprises a plurality of compute-intensive operators, and wherein the new computation graph is divided into the sub-computation graphs, based on an output property of each layer of the new computation graph and a platform capacity of a platform on which the new computation graph is to be executed.

Example 28 includes the apparatus of any one of Examples 25-27, wherein the means for dividing the new computation graph into the sub-computation graphs comprises: means for obtaining a dividing parameter by means of heuristic rule, based the output property of each layer; means for obtaining a buffer size for each layer, which is to be allocated for an output batch and a weight for the layer, based on the output property of the layer; and means for dividing the layers sequentially, in a topology order of the new computation graph, into the sub-computation graphs, based on the dividing parameter, the buffer size and the platform capacity.

Example 29 includes the apparatus of any one of Examples 25-28, wherein the means for dividing the layers sequentially, in the topology order of the new computation graph, into the sub-computation graphs, based on the dividing parameter, the buffer size and the platform capacity comprises: means for obtaining a reduced buffer size for each layer based on the dividing parameter and the buffer size for the layer; and means for dividing one or more sequential layers, for which a sum of the reduced buffer sizes for the one or more sequential layers is smaller than or equal to the platform capacity and a sum of the reduced buffer sizes for the one or more sequential layers and a following layer is greater than the platform capacity, into a sub-computation graph.

Example 30 includes the apparatus of any one of Examples 25-29, wherein each of the compute-intensive operators of the new computation graph outputs an output activation, and the output activations of the compute-intensive operators of each layer form an output batch, and wherein the output property comprises a size of an output batch for each layer and/or a size of an output activation of each compute-intensive operator of the new computation graph.

Example 31 includes the apparatus of any one of Examples 25-30, wherein the dividing parameter comprises a batch dividing number and a spatial dividing number, wherein the batch dividing number corresponds to a number of sub-batches which an output batch is to be divided into, and the spatial dividing number corresponds to a number of sub-activations which an output activation is to be divided into.

Example 32 includes the apparatus of any one of Examples 25-31, wherein the reduced buffer size is expressed by:

$${a}_{R\_i} = {w}_{i} + {a}_{i} \times \frac{1}{x \times y} ,$$

wherein a_{R_i} Indicates the reduced buffer size for a i^{th} layer of the new computation graph in the topology order, wᵢ indicates the weight for the i^{th} layer, aᵢ indicates the buffer size for the i^{th} layer, x indicates the batch dividing number, y indicates the spatial dividing number, and each of the a_{R_i}, i, wᵢ, aᵢ, x and y is greater than 0.

Example 33 includes the apparatus of any one of Examples 25-32, wherein the platform capacity comprises a size of a data cache unit (DCU) and a size of a middle level cell (MLC) of a central processing unit (CPU) on which the new computation graph is to be executed.

Example 34 includes the apparatus of any one of Examples 25-33, wherein for each sub-computation graph:

$${Σ}_{i = N}^{i = M} {a}_{R\_i} \leq T \times ( {L}_{1} + {L}_{2} ) < {Σ}_{i = N}^{i = M + 1} {a}_{R\_i} ,$$

wherein N indicates a start layer of the sub-computation graph, M indicates a last layer of the sub-computation graph, T indicates a threshold set based on the CPU, L₁ indicates the size of the DCU, L₂ indicates the size of the MLC, the N, M, L₁ and L₂ are greater than 0, and T is greater than 0 and smaller than or equal to 1.

Example 35 includes the apparatus of any one of Examples 25-34, wherein the means for fusing the compute-intensive operators, in each of the sub-computation graphs comprises: for each sub-computation graph, means for dividing the output batch for each layer of the sub-computation graph, into the sub-batches, by the batch dividing number; means for dividing the output activation of each compute-intensive operator of the sub-computation graph, into the sub-activations, by the spatial dividing number; and means for fusing the compute-intensive operators, in the sub-computation graph, based on the sub-batches and the sub-activations.

Example 36 includes the apparatus of any one of Examples 25-35, wherein each output activation comprises one or more output samples, and wherein the means for dividing the output activation of each compute-intensive operator of the sub-computation graph, into the sub-activations, by the spatial dividing number comprises: means for dividing each output sample of the output activation into sub-samples, along a height direction of the sample, by the spatial dividing number.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the appended claims and the equivalents thereof.

1. A method for optimizing deep learning computation graph, comprising:
obtaining a deep learning computation graph including compute-intensive operators and memory-intensive operators;
fusing the memory-intensive operators into the compute-intensive operators to generate a new computation graph;
dividing the new computation graph into sub-computation graphs; and
fusing compute-intensive operators, in each of the sub-computation graphs, to generate an optimized computation graph.

2. The method of claim 1, wherein fusing the memory-intensive operators into the compute-intensive operators includes:
fusing one or more sequential memory-intensive operators into a previous or a following compute-intensive operator.

3. The method of claim 1, wherein the new computation graph includes a plurality of layers, and each of the layers includes a plurality of compute-intensive operators, and
wherein the new computation graph is divided into the sub-computation graphs, based on an output property of each layer of the new computation graph and a platform capacity of a platform on which the new computation graph is to be executed.

4. The method of claim 3, wherein dividing the new computation graph into the sub-computation graphs includes:
obtaining a dividing parameter by means of heuristic rule, based the output property of each layer;
obtaining a buffer size for each layer, which is to be allocated for an output batch and a weight for the layer, based on the output property of the layer; and
dividing the layers sequentially, in a topology order of the new computation graph, into the sub-computation graphs, based on the dividing parameter, the buffer size and the platform capacity.

5. The method of claim 4, wherein dividing the layers sequentially, in the topology order of the new computation graph, into the sub-computation graphs, based on the dividing parameter, the buffer size and the platform capacity includes:
obtaining a reduced buffer size for each layer based on the dividing parameter and the buffer size for the layer; and
dividing one or more sequential layers, for which a sum of the reduced buffer sizes for the one or more sequential layers is smaller than or equal to the platform capacity and a sum of the reduced buffer sizes for the one or more sequential layers and a following layer is greater than the platform capacity, into a sub-computation graph.

6. The method of claim 5, wherein each of the compute-intensive operators of the new computation graph outputs an output activation, and the output activations of the compute-intensive operators of each layer form an output batch, and
wherein the output property comprises a size of an output batch for each layer and/or a size of an output activation of each compute-intensive operator of the new computation graph.

7. The method of claim 6, wherein the dividing parameter includes a batch dividing number and a spatial dividing number,
wherein the batch dividing number corresponds to a number of sub-batches which an output batch is to be divided into, and
the spatial dividing number corresponds to a number of sub-activations which an output activation is to be divided into.

8. The method of claim 7, wherein the reduced buffer size is expressed by:
$${a}_{R\_i} = {w}_{i} + {a}_{i} \times \frac{1}{x \times y} ,$$
wherein a_{R_i} indicates the reduced buffer size for a i^{th} layer of the new computation graph in the topology order, wᵢ indicates the weight for the i^{th} layer, aᵢ indicates the buffer size for the i^{th} layer, x indicates the batch dividing number, y indicates the spatial dividing number, and each of the a_{R_i}, i, wᵢ, aᵢ, x and y is greater than 0.

9. The method of claim 8, wherein the platform capacity includes a size of a data cache unit (DCU) and a size of a middle level cell (MLC) of a central processing unit (CPU) on which the new computation graph is to be executed.

10. The method of claim 9, wherein for each sub-computation graph:
$${\sum }_{i = N}^{i = M} {a}_{R\_i} \leq T \times ( {L}_{1} + {L}_{2} ) < {\sum }_{i = N}^{i = M + 1} {a}_{R\_i} ,$$
wherein N indicates a start layer of the sub-computation graph, M indicates a last layer of the sub-computation graph, T indicates a threshold set based on the CPU, L₁ indicates the size of the DCU, L₂ indicates the size of the MLC, the N, M, L₁ and L₂ are greater than 0, and T is greater than 0 and smaller than or equal to 1.

11. The method of claim 7, wherein fusing the compute-intensive operators, in each of the sub-computation graphs includes, for each sub-computation graph:
dividing the output batch for each layer of the sub-computation graph, into the sub-batches, by the batch dividing number;
dividing the output activation of each compute-intensive operator of the sub-computation graph, into the sub-activations, by the spatial dividing number; and
fusing the compute-intensive operators, in the sub-computation graph, based on the sub-batches and the sub-activations.

12. The method of claim 11, wherein each output activation comprises one or more output samples, and
wherein dividing the output activation of each compute-intensive operator of the sub-computation graph, into the sub-activations, by the spatial dividing number comprises:
dividing each output sample of the output activation into sub-samples, along a height direction of the sample, by the spatial dividing number.

13. An apparatus for optimizing deep learning computation graph, comprising:
interface circuitry; and
processor circuitry coupled with the interface circuitry and configured to:
obtain a deep learning computation graph comprising compute-intensive operators and memory-intensive operators;
fuse the memory-intensive operators into the compute-intensive operators to generate a new computation graph;
divide the new computation graph into sub-computation graphs; and
fuse compute-intensive operators, in each of the sub-computation graphs, to generate an optimized computation graph.

14. The apparatus of claim 13, wherein to fuse the memory-intensive operators into the compute-intensive operators, the processor circuitry is to:
fuse one or more sequential memory-intensive operators into a previous or a following compute-intensive operator.

15. The apparatus of claim 13, wherein the new computation graph includes a plurality of layers, and each of the layers comprises a plurality of compute-intensive operators, and
wherein the new computation graph is divided into the sub-computation graphs, based on an output property of each layer of the new computation graph and a platform capacity of a platform on which the new computation graph is to be executed.

16. The apparatus of claim 15, wherein to divide the new computation graph into the sub-computation graphs, the processor circuitry is to
obtain a dividing parameter by means of heuristic rule, based the output property of each layer;
obtain a buffer size for each layer, which is to be allocated for an output batch and a weight for the layer, based on the output property of the layer; and
divide the layers sequentially, in a topology order of the new computation graph, into the sub-computation graphs, based on the dividing parameter, the buffer size and the platform capacity.

17. The apparatus of claim 16, wherein to divide the layers sequentially, in the topology order of the new computation graph, into the sub-computation graphs, based on the dividing parameter, the buffer size and the platform capacity, the processor circuitry is to:
obtain a reduced buffer size for each layer based on the dividing parameter and the buffer size for the layer; and
divide one or more sequential layers, for which a sum of the reduced buffer sizes for the one or more sequential layers is smaller than or equal to the platform capacity and a sum of the reduced buffer sizes for the one or more sequential layers and a following layer is greater than the platform capacity, into a sub-computation graph.

18. The apparatus of claim 17, wherein each of the compute-intensive operators of the new computation graph outputs an output activation, and the output activations of the compute-intensive operators of each layer form an output batch, and
wherein the output property comprises a size of an output batch for each layer and/or a size of an output activation of each compute-intensive operator of the new computation graph.

19-23. (canceled)

24. A non-transitory computer-readable medium having instructions stored thereon, the instructions when executed by a processor cause the processor to:
obtain a deep learning computation graph comprising compute-intensive operators and memory-intensive operators;
fuse the memory-intensive operators into the compute-intensive operators to generate a new computation graph;
divide the new computation graph into sub-computation graphs; and
fuse compute-intensive operators, in each of the sub-computation graphs, to generate an optimized computation graph.

25. The non-transitory computer-readable medium of claim 24, wherein the new computation graph comprises a plurality of layers, and each of the layers comprises a plurality of compute-intensive operators, and
wherein the new computation graph is divided into the sub-computation graphs, based on an output property of each layer of the new computation graph and a platform capacity of a platform on which the new computation graph is to be executed.
